(19) United States
(12) Patent Application Publication
(10) Pub. No.: US 2010/0089496 A1
(43) Pub. Date: Apr. 15, 2010

(54) ROUTER AND ROUTER ACCESSORY

(76) Inventor: Alan David Barnes, Victoria (AU)

Correspondence Address: JOHN ALEXANDER GALBREATH, 2516 CHESTNUT WOODS CT, REISTERSTOWN, MD, 21136, US

(21) Appl. No.: 12/529,190

(22) PCT Filed: Mar. 3, 2008
(86) PCT No.: PCT/AU08/00287

§ 371 Date: Aug. 31, 2009

(30) Foreign Application Priority Data
Mar. 2, 2007 (AU) 2007901096

(51) Int. Cl. B27C 5/10; B27C 5/00

(52) U.S. Cl. 144/48.6; 144/144.1

(57) ABSTRACT

A router accessory for attachment to the router base allows a plunging router to cut a mortice in a workpiece. The baseplate accessory has a central aperture for the bit and width dividing fingers projecting from the base capable of straddling the workpiece and upon rotation to abut the sides of the workpiece and aim the bit half way between the workpiece sides. A router modified with a built-in baseplate with this capability is described. A dedicated router with the same feature which allows deep plunging such as for mortice locks is described.

### FIELD OF THE INVENTION

This invention concerns plunging routers and accessories for the same.

### BACKGROUND OF THE INVENTION

Plunging routers can be locked against plunging to produce undercut grooves, bevels and special profiles when used like a spindle moulder, but its main work is in the excision of parallel sided grooves where the plunging action permits the creation of stopped grooves.

Routers are versatile tools and proposals for attachments to perform special cuts are shown in U.S. Pat. No. 4,630,656 and U.S. Pat. No. 5,123,463 but these function as jigs which rely on finger adjustment of the accessory to yield reproducible accurate cuts. A specific example which allows mortices to be cut and dowel holes to be bored with a plunge router is U.S. Pat. No. 6,065,913. In this patent the operator's adjustments define the mortice path for the cutter. U.S. Pat. No. 5,452,751 shows a router with a modified baseplate bearing pairs of bores which lie successively closer together in a direction from the edge toward the cutter aperture. Pins protrude from two bores selected by the operator and the mortice is cut by making two side by side passes, each pass being made with a pin against a straight edge.

U.S. Pat. No. 4,197,887 proposes a baseplate for a router with a pair of posts which project from the baseplate and whose distance from the cutter between them is adjustable because a pair of diametrical slots in the plate allow the posts to nip opposed faces of the workpiece.

U.S. Pat. No. 4,763,707 discloses a baseplate with posts which are attached at the perimeter to the baseplate at a spacing much wider than the width of a furniture stile or rail, making width adjustment unnecessary by teaching that a constant rotating force during cutting centralises the cutter path.

When frames require mortices, a tradesman will prefer to use a purpose-built morticer in a workshop. When the job is at a site, a portable morticer is an option but these are relatively expensive because they include a router as a component in addition to threaded parts for finding the central axis of the mortice and guiding the bit to that axis.

Mortice locks for doors are still popular worldwide and often doors are delivered to a site without a mortice to house the lock. The guides supplied with a plunging router are incapable of guaranteeing an accurate mortice in the edge of a door where the mortice may extend over 70% of the door thickness leaving a slim margin on each side of the lock. The router is capable of an accurate parallel sided cut approximately 60 mm deep, but many locks require a housing 75 mm deep and this is beyond the average router available at the priority date.

A special jig to cut mortices would only be feasible if the jig could be easily transferred from door to door, all doors required the same width of mortice and there were a sufficient number of doors to make jig construction worthwhile.

### SUMMARY OF THE INVENTION

The first accessory aspect of the invention provides a router accessory which allows a plunging router to perform a morticing operation on a workpiece having a pair of parallel sides comprising a baseplate adapted to be mounted on the router ring base, the baseplate defining a central aperture to admit the router bit, width dividing members extending from the ring base capable of straddling the workpiece and upon rotation to abut the sides of the workpiece thereby aiming the router bit half way between the sides.

The dividing members may be or include a pair of mutually parallel fingers. The fingers may each be surrounded by a rotatable sleeve.

The fingers may instead each support at least one pair of wheels of equal diameter.

The fingers preferably each support two pairs of wheels which are mutually spaced, one at or near the distal end of the finger, the other proximal to the baseplate. For specialised wider jobs, the fingers may be cranked.

The baseplate may have screw holes for admitting screws which engage the lugs for the template guide.

The second accessory aspect of the invention provides a router accessory comprising a baseplate with attachment means capable of locking the plate to the base of a standard router, wherein the baseplate of the accessory has a central aperture to admit the shaft of the router bit, width dividing members extending from the accessory baseplate for straddling the workpiece and upper rotation to abut the sides of the workpiece thereby aiming the router bit half way between the sides.

The router aspect of the invention provides a dedicated router for morticing comprising a plunging router for performing morticing operations on a workpiece with two parallel sides comprising a body having a motor part and a width divider part, the parts being arranged to plunge the motor part into the divider part, the width divider part having a pair of projecting posts for straddling the workpiece which act as guides for the plunging motor part.

The posts may be joined by a bridge which includes a bearing through which the bit slides during plunging.

The posts may support a table lying at 90° to the posts, the purpose being to contact the surface of the workpiece which is to be cut. The table may be a thin rigid plate with an aperture between the posts for sighting the mortice and allowing chips to escape.

The body may have a pair of hollow tubes extending diametrically from the body into which the posts plunge. The pair of router grips may be between the pair of hollow tubes.

### BRIEF DESCRIPTION OF THE DRAWINGS

One embodiment of the invention is now described with reference to the accompanying drawings, in which:

FIG. 1 is a perspective view of the accessory.

FIG. 2 is a section through one of the fingers.

FIG. 3 is a plan section through a variant of the accessory shown in FIGS. 1 and 2.

FIG. 4 shows the accessory on the router presented to the door in end view.

FIG. 5 shows the accessory engaging the door.

FIG. 6 is a partial section of a dedicated router.

FIG. 7 is a plan of the bridge and fingers of the router of FIG. 6.

FIG. 8 is a partial sectional view of a router accessory which is intended for attachment to a standard router but which confers morticing function.

FIG. 9 is a plan of the accessory of FIG. 8.

FIG. 10 is a perspective of the embodiment of FIG. 9 showing the accessory straddling a workpiece and the mortice therein.

FIG. 11 is a perspective of a variant of FIG. 10.

FIG. 12 is a perspective of a dedicated router just for morticing.

### DETAILED DESCRIPTION WITH RESPECT TO THE DRAWINGS

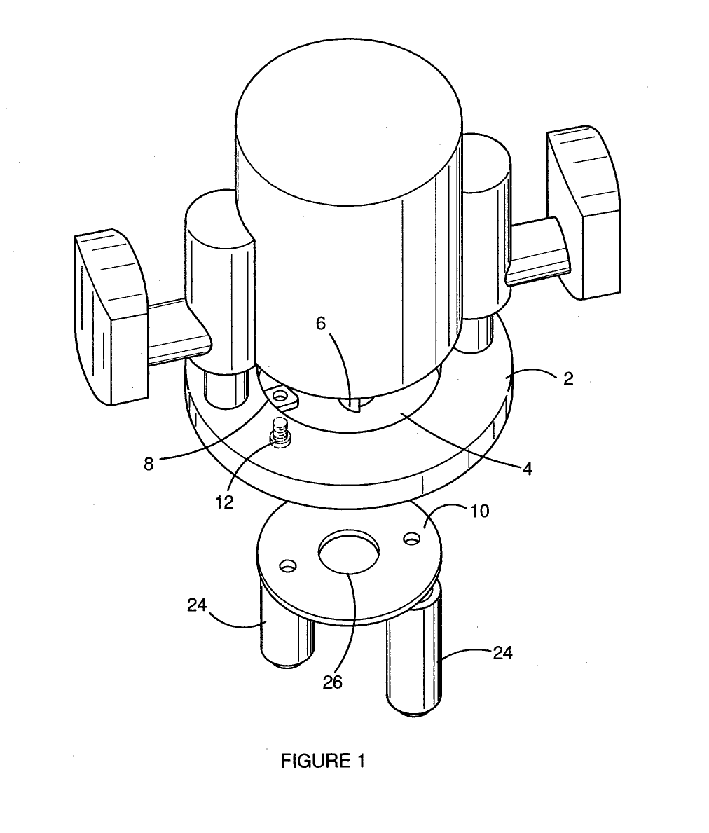

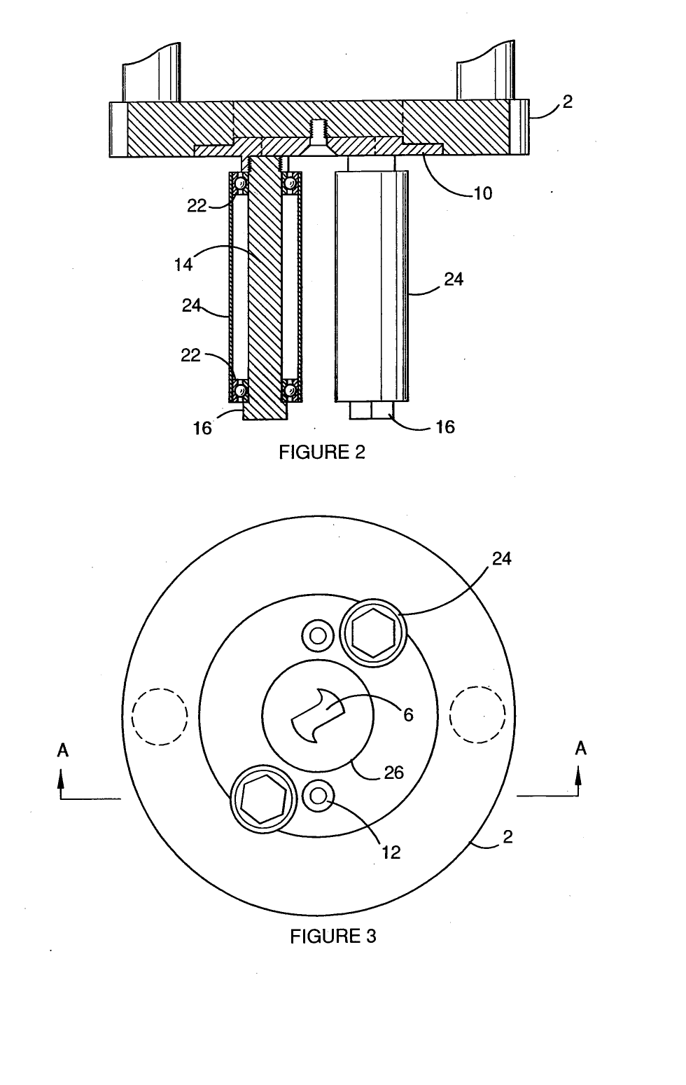

Referring now to FIGS. 1 and 2 of the drawings, the ring base 2 of the plunging router defines the circular aperture 4 through which the router bit 6 advances in order to cut. A pair of diametric lugs 8 (one shown) project horizontally into the aperture and these lugs support steel baseplate 10. Screws 12 lock and release the plate.

A pair of posts 14 (one shown) have a head 16 at the distal end and a threaded portion at the opposite end. Ball bearings 22 are a slide fit on the post. The bearings are retained in the distal and proximal positions by sleeve 24. Bit 6 projects through window 26 in the baseplate 10. The sleeve separation is 100 mm. The post separation is 120 mm.

Referring now to FIG. 3, the steel baseplate 10 does not fit within the circular aperture 4 as does the plate in FIG. 1. The baseplate is larger and abuts the bottom of the ring base but is still retained by screws engaging the diametric lugs 8.

The plate has a pair of integral spigots 30 which are internally threaded to receive the threaded end of posts 14. Each post has head 16 as before and a pair of ball bearings 32, one at the spigot, the other at the head support sleeve 24.

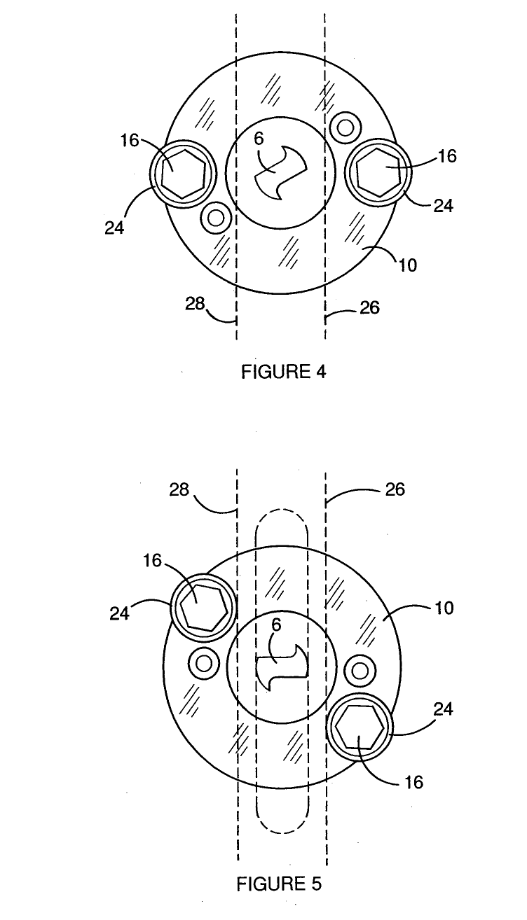

Referring now to FIGS. 4 and 5, the router base is offered up to the edge of the door. The fingers straddle the door and the base contacts the edge of the door. The operator rotates the base until the sleeve contacts the obverse face 26 and reverse faces 28 of the door. The router plunges and repeated passes are made by moving the base backwards and forwards until the mortice attains the desired depth.

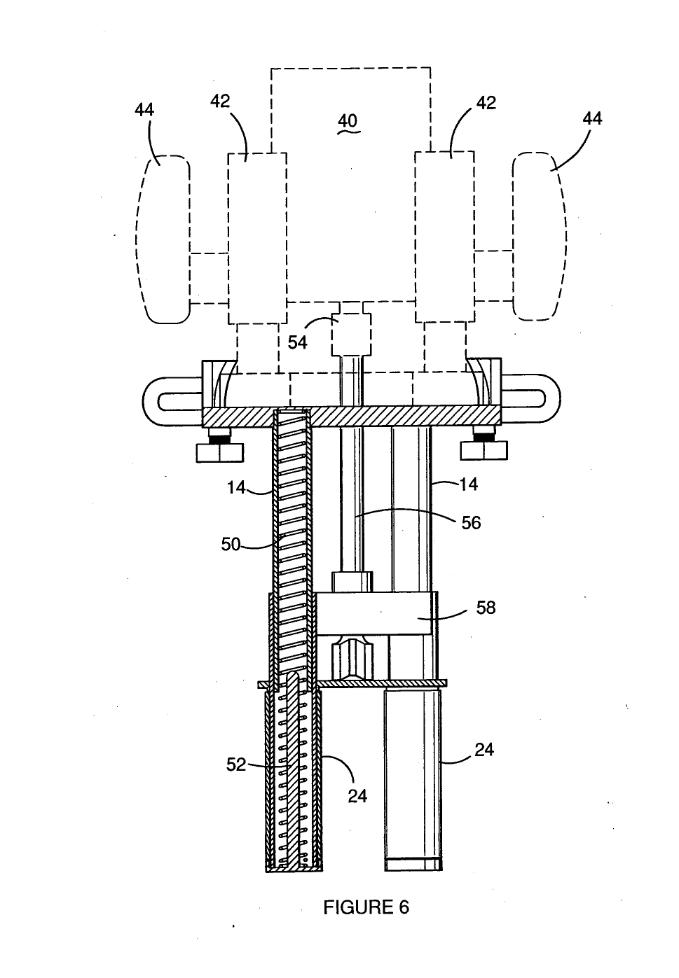

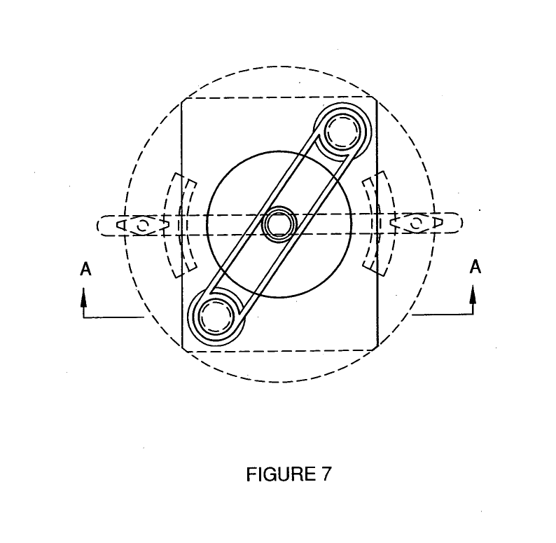

Referring now to FIGS. 6 and 7, the motorised body 40 of a router is bored and tapped to create mounts for a pair of hollow cylindrical pillars 42 located at 90° to router grips 44. The width dividing posts 14 have rotatable sleeves 24 for straddling the workpiece. The sleeves rotate as the router travels backwards and forwards along the workpiece because the mortice is cut in stages, the cuts or passes increasing in depth. The exposed sliding portion 48 of the posts 14 is 100 mm in length. This allows a cut of 100 mm depth and a 100 mm plunge into the hollow cylindrical legs. The plunge motion is countered by coil spring 50. Spring guide 52 assists smooth motion.

This geometry requires the router bit to operate at a greater than usual distance from the chuck 54. Accordingly the router bit is constructed as a plain shaft 56, 1020 mm long, one end of which carries the screw in HSS bit 6. The shaft is supported midway between the posts by a horizontal bridge comprising a pair of transverse inertial parallel webs 58 fixed to the posts adjacent the upper ends of the sleeves. The bridge has a central vertical bearing 60 through which the shaft 56 slides to reach the router chuck 54. About 10 mm below the bridge webs 58, there is a flat, horizontal, rectangular table 62 supported on posts 14. The purpose of this table is to allow the whole assembly to make even contact with the surface to be morticed and to ensure the cutter axis perpendicular. The table has a window 64 through which the chips escape and the bit 6 may extend. The motorised body and the shaft are able to plunge up to 100 mm but in a job such as a furniture stile, stops (not shown) would be first clamped to the stile. These would determine the positions of the ends of the mortice. The correct width of the bit is then selected and the shaft tightened in the chuck. The grips are used to cause the sleeves to straddle the stile and the table to contact the surface of the stile.

The grips are rotated to bring the sleeves into contact with the two opposite sides of the stile. The first cut is made between the stops. The second pass is made by plunging the router and cutting between the stops. Plunging and passing is repeated until the mortice has reached the correct depth. The operator is free to raise the table at any stage allowing chips to leave the mortice.

This router is a dedicated router in that it is reserved for morticing or cutting central grooves in stiles and rails and for cutting lock mortices in doors.

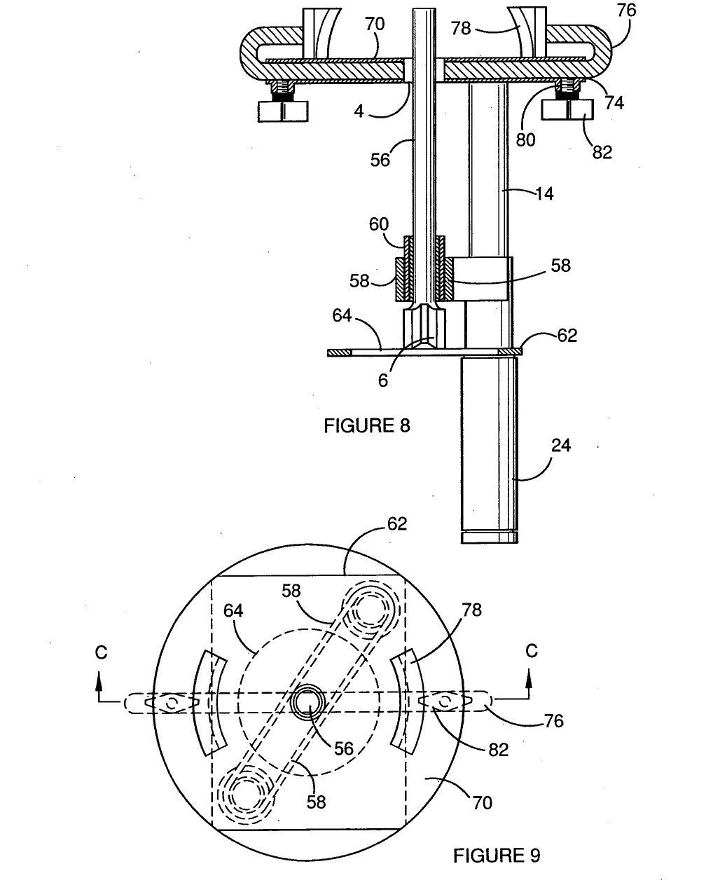

Referring now to FIGS. 8 and 9, the accessory shown is intended to be a conversion component enabling a standard route to do morticing jobs. Although routers are made in different sizes and power ratings, they tend to have circular bases 2 falling within a limited diameter range.

The base 70 of the accessory has a central aperture 4 for admitting shaft 56 and two bores 72 which house the ends of posts 14. The bridge 58, sleeves 46 and bearings 64 are present as in the FIG. 6 embodiment, but the spring guide 52 is at the opposite end of post 14.

A bore 74 (see FIG. 9) passes diametrically through the thickness of the base 70. Bore 74 houses the ends of a pair of U-shaped clamps 76. The clamps each have an arcuate pad 78 intended to engage the circular edge of router base 2. The base has a pair of threaded bores 80 which intersect bore 74.

Finger screws 82 lock the clamps at the desired spacing.

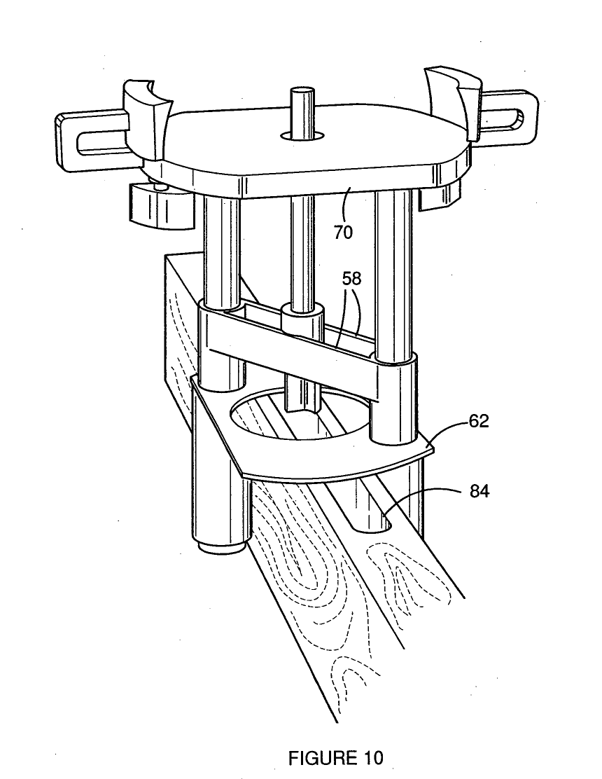

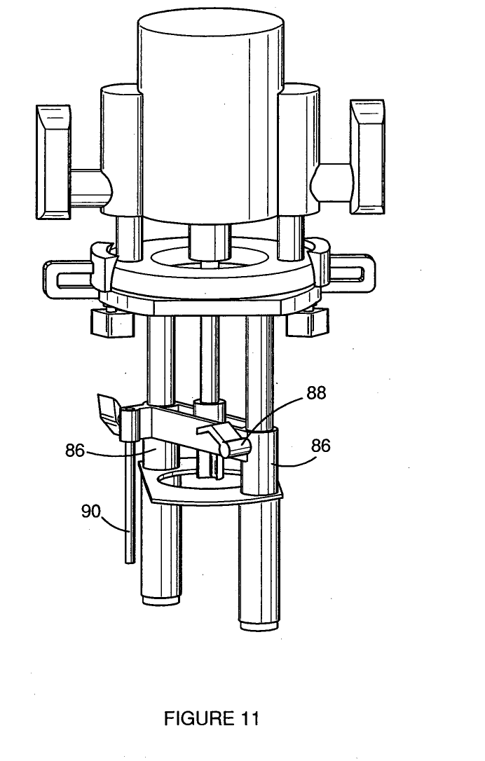

In FIG. 10, the table 62 is shown sliding along the edge of a stile. Mortice 84 has already been cut. The distance between webs 58 and base 70 represents the plunging depth. In FIG. 11, the bridge webs extend from collars 86. Screw lock 88 allows the associated collar to be locked on the post 14. An adjustable depth stop 90 extends from the opposite collar.

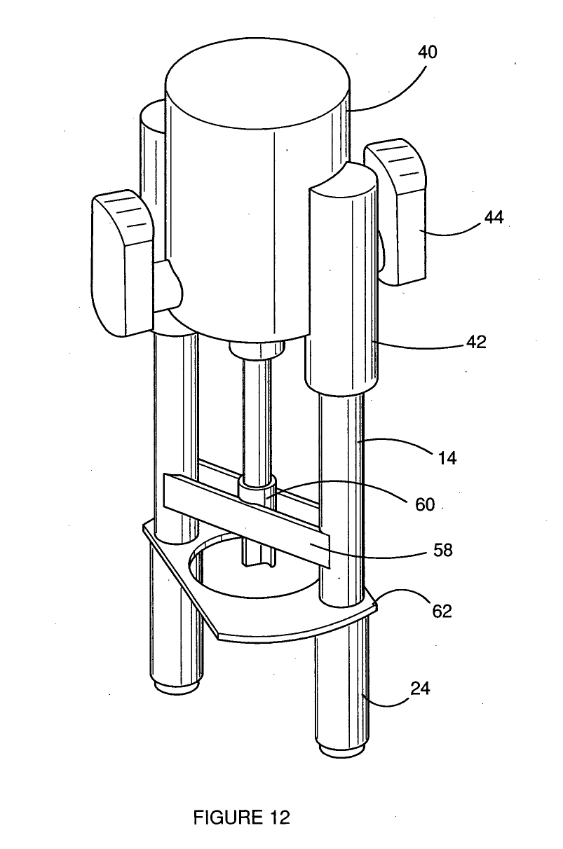

Referring now to FIG. 12, a router dedicated to morticing has a body 40 with a pair of downwardly extending hollow tubes 42 projecting from the body. A pair of parallel telescoping posts 14 project downwardly from the tubes housing return coil springs (not shown).

The posts are mutually connected by a pair of webs 58 which support central bearing 60. The posts support table 62.

Shaft 56 slides in bearing 60 and has a threaded lower end which receives a screw in bit 6.

We have found the advantages of the above embodiments to be:
1. The wheels or rotary sleeves improve the feel of the router as it cuts the mortice.
2. The rate of completion of one job and moving to the next such as in door work is high and makes optimum use of a tradesman's time.
3. The ability to plunge to the full depth of a lock mortice is possible by using enlarged bit travel.

It is to be understood that the word “comprising” as used throughout the specification is to be interpreted in its inclusive form, ie. use of the word “comprising” does not exclude the addition of other elements.

It is to be understood that various modifications of and/or additions to the invention can be made without departing from the basic nature of the invention. These modifications and/or additions are therefore considered to fall within the scope of the invention.

1. A router accessory which allows a plunging router to perform a morticing operation on a workpiece with a pair of parallel sides, comprising a baseplate adapted to be mounted on the router ring base, the baseplate defining a central aperture to admit the router bit, width dividing members extending from the ring base capable of straddling the workpiece and upon rotation to abut the parallel sides of the workpiece thereby aiming the bit half way between the sides.

2. A router accessory as claimed in claim 1, wherein the dividing members include a pair of mutually parallel fingers.

3. A router accessory as claimed in claim 2, wherein the fingers are each surrounded by a rotatable sleeve.

4. A router accessory as claimed in claim 2, wherein the fingers each support at least one pair of rotatable wheels of equal diameter.

5. A router accessory as claimed in claim 4, wherein the fingers each support two pairs of wheels which are mutually spaced, one at or near the distal end of the finger, the other proximal to the baseplate.

6. A router accessory as claimed in claim 2, wherein the fingers are cranked.

7. A router accessory as claimed in claim 1, wherein the baseplate has screw holes for admitting screws which engage the lugs for the template guide as herein defined.

8. A router accessory comprising a baseplate with attachment means capable of locking the plate to the base of a standard router, wherein the baseplate of the accessory has a central aperture to admit the shaft of the router bit, width dividing members projecting from the accessory baseplate for straddling a workpiece with parallel sides thereby aiming the router bit halfway between the sides.

9. A plunging router adapted for morticing a workpiece with two parallel sides, comprising a body having a motor part capable of plunging and a width divider part, the parts being arranged to plunge the motor part into the divider part, the width divider part having a pair of projecting posts for straddling the workpiece which posts act as guides for the plunging motor part.

10. A plunging router as claimed in claim 10, wherein the posts may be joined by a bridge which includes a bearing through which the bit slides during plunging.

11. A plunging router as claimed in claim 9, wherein the posts may support a table lying at 90° to the posts, the purpose being to contact the surface of the workpiece which is to be cut.

12. A plunging router as claimed in claim 11, wherein the table may be a thin rigid plate with an aperture between the posts for sighting the mortice and allowing chips to escape.

13. A plunging router as claimed in claim 9, wherein the body may have a pair of hollow tubes extending diametrically from the body into which the posts plunge.

14. A plunging router as claimed in claim 13, wherein a pair of router grips lie between the pair of hollow tubes.

15. (canceled)

16. (canceled)

17. (canceled)
